(19) United States
(12) Patent Application Publication
(10) Pub. No.: US 2017/0338768 A1
(43) Pub. Date: Nov. 23, 2017

(54) CLAMPS FOR INSTALLATION OF PHOTOVOLTAIC MODULES TO ROOFS

(71) Applicant: SUNEDISON, INC., Maryland Heights, MO (US)

(72) Inventors: Marath Prakash, Bangalore (IN); Anurag Mapati, Bangalore (IN); Bharat Malapareddy, Bangalore (IN); Selvam Ramasamy, Bangalore (IN); Manickam Narayanan, Chennai, TN (IN); Rajesh Manapat, Bangalore, Karnataka (IN); Nagendra Srinivas Cherukupalli, Cupertino, CA (US)

(21) Appl. No.: 15/522,662

(22) PCT Filed: Oct. 26, 2015
(86) PCT No.: PCT/US15/57404

§ 371 Date: Apr. 27, 2017

Related U.S. Application Data
(60) Provisional application No. 62/069,083, filed on Oct. 27, 2014.

(51) Int. Cl. H02S 20/23; F16B 2/12; F24J 2/52; H02S 30/10; F24J 2/46

(52) U.S. Cl. CPC H02S 20/23; F24J 2/5249; F24J 2/5258; H02S 30/10; F16B 2/12; F24J 2002/4663

(57) ABSTRACT

Clamping assemblies for securing a solar module to a structure include a base, a bracket, and a fastener. The base may be attached to a multi-planar roof of the structure. The base and the bracket together define a mounting region for receiving a portion of the solar module. The fastener connects the base and the clamp and can selectively apply a clamping force to the portion of the solar module.

### CROSS-REFERENCE TO RELATED APPLICATION

This application claims priority to U.S. Provisional Patent Application No. 62/069,083 filed on 27 Oct. 2014, the entire disclosure of which is hereby incorporated by reference in its entirety.

### FIELD

This disclosure relates generally to mounting systems for solar modules and, more specifically, to clamps for mounting solar modules to a mounting surface of a structure.

### BACKGROUND

Solar modules are devices which convert solar energy into other forms of useful energy (e.g., electricity or thermal energy). Such modules are typically positioned above an underlying support surface by a rack. This rack may be configured to position the solar module at an angle relative to the support surface to minimize an angle of incidence between the solar module and the sun's rays. Minimizing this angle of incidence increases the amount of solar energy gathered by the solar module.

When the underlying surface is the roof of a structure, the racks must comply with wind loading requirements that are meant to prevent racks from being blown from the roof. Some known roof mounted racks are fastened to the roof using a mechanical anchor that penetrates the roof to attach to the support joists of the structure. Each roof penetration creates a potential inlet for water. Another method of connecting solar modules to rooftops is to add heavy ballast to weigh down the solar modules. Water and weight by ballast may diminish and/or damage the structural integrity of the roof and the building.

Mounting surfaces on a structure which support solar module racks are not typically simple, flat surfaces. Instead, these mounting surfaces often include a number of undulations, protrusions, ridges, valleys and/or angled portions, particularly in the case of a metal corrugated roof.

This Background section is intended to introduce the reader to various aspects of the art that may be related to various aspects of the present disclosure, which are described and/or claimed below. This discussion is believed to be helpful in providing the reader with background information to facilitate better understanding of the various aspects of the present disclosure. Accordingly, it should be understood that these statements are to be read in this light, and not as admissions of prior art.

### BRIEF SUMMARY

One aspect of this disclosure is a solar module clamp for securing a solar module to a structure. The solar module clamp includes a base, a t-shaped bracket, and a fastener. The base is configured for attachment to the structure and includes a first segment and a second segment spaced apart from one another and connected by a third segment. The bracket includes a first portion and a second portion. The first portion is connected substantially orthogonal to the second portion. The fastener extends through the t-shaped bracket, is connected to the base, and is configured to selectively clamp the solar module between the base and the t-shaped bracket.

Another aspect is a solar module clamp for securing a solar module to a structure. The solar module clamp includes a base, a bracket, and a fastener. The base is configured for attachment to the structure and includes a top and a bottom spaced apart and connected by two sides. The top, bottom, and sides define a volume, and the top has an opening defined therethrough. The bracket includes an upper portion and a lower portion substantially parallel and connected to the upper portion. The fastener extends from the volume through the top opening, is connected to the bracket lower portion, and is configured to selectively clamp the solar module between the base and the bracket upper portion.

Another aspect is a solar module assembly including a solar panel, a frame coupled to the solar panel, and a clamp. The clamp includes a base, a bracket, and a fastener. The base is configured for attachment to a structure and includes a first segment and a second segment spaced apart and connected by a third segment. The fastener extends through the bracket, is connected to the base, and is configured to selectively clamp the frame between the base and the bracket.

Yet another aspect is a clamping assembly for securing a solar module to a structure. The clamping assembly includes a base, a bracket, and a fastener. The base is configured for attachment to a multi-planar roof of the structure. The base and the bracket collaboratively define a mounting region for receiving a portion of the solar module. The fastener connects the base and the clamp and is configured to selectively apply a clamping force to the portion of the solar module.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example solar module;

FIG. 2 is a cross-sectional view of the solar module shown in FIG. 1 taken along the line A-A;

FIG. 3 is a side view of a solar module assembly, including an example solar module clamp, mounted to a structure;

FIG. 4 is a perspective view of a solar module assembly, including another example solar module clamp, mounted to a structure;

FIG. 5 is a perspective view of a solar module assembly, including another example solar module clamp, mounted to a structure;

FIG. 6 is a perspective view of yet another example solar module clamp mounted to a structure;

FIG. 7 is a side view a solar module assembly, including the solar module clamp shown in FIG. 6, mounted to a structure;

FIG. 8 is a is a perspective view of another example solar module clamp mounted to a structure;

FIG. 9 is an end view of the solar module clamp shown in FIG. 8;

FIG. 10 is an exploded end view of the solar module clamp shown in FIG. 9;

FIG. 11 is a perspective view of an example base for use in the solar module clamp shown in FIG. 6;

FIG. 12 is a perspective view of another example base for use in the solar module clamp shown in FIG. 6;

FIG. 13 is a perspective view of a solar module assembly, including a solar module clamp, mounted to a structure;

FIG. 14 is a perspective view of another example base for use in the solar module clamp shown in FIG. 13;

FIG. 15 is a perspective view of a solar module assembly, including a solar module clamp, mounted to a structure;

FIG. 16 is a perspective view of an example base for use in the solar module clamp shown in FIG. 15;

FIG. 17 is a perspective view of the base shown in FIG. 16 with certain elements omitted to show underlying features; and

FIG. 18 is a perspective view of another example base for use in the solar module clamp shown in FIG. 15.

Like reference symbols in the various drawings indicate like elements.

### DETAILED DESCRIPTION

This disclosure relates generally to mounting systems for solar modules and, more specifically, to clamps for mounting solar modules to a mounting surface of a structure.

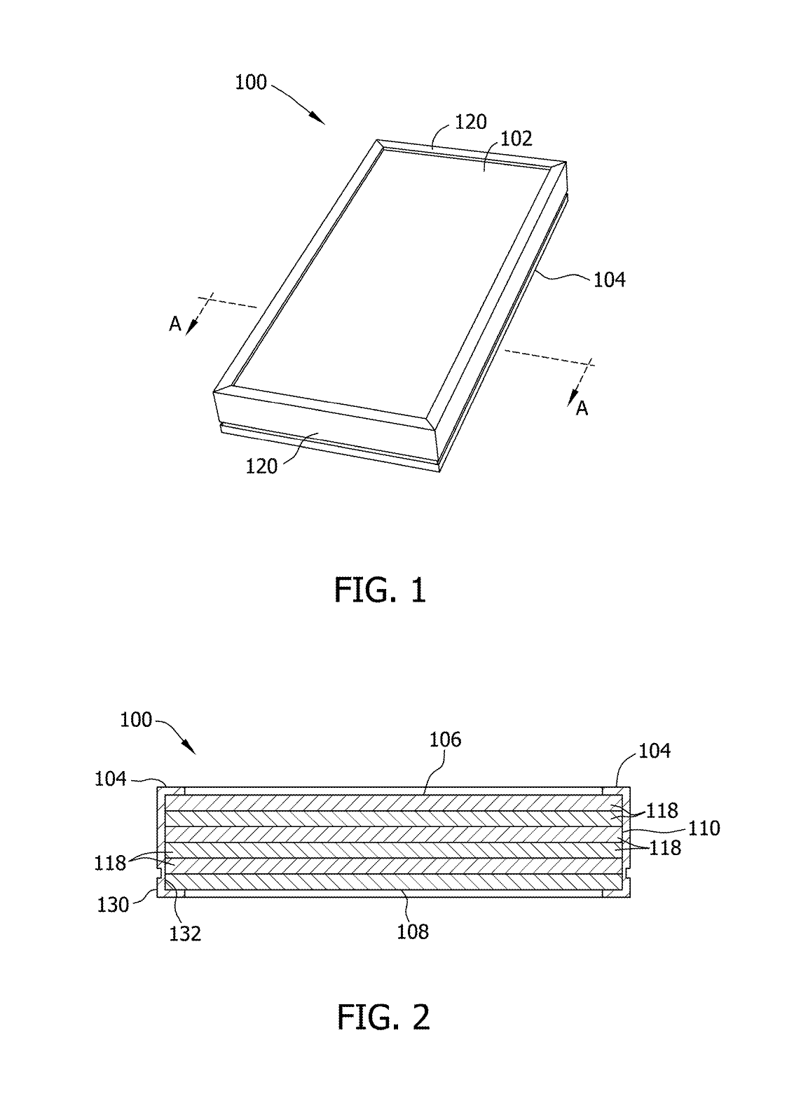

Referring initially to FIGS. 1 and 2, a solar module of one embodiment is indicated generally at 100. A perspective view of solar module 100 is shown in FIG. 1. FIG. 2 is a cross-sectional view of solar module 100 taken at line A-A as shown in FIG. 1. Solar module 100 includes a solar laminate 102 and a frame 104 circumscribing solar laminate 102.

Solar laminate 102 includes a top surface 106 and a bottom surface 108 (shown in FIG. 2). Edges 110 extend between top surface 106 and bottom surface 108. In this embodiment, solar laminate 102 is rectangular shaped. In other embodiments, solar laminate 102 may have any suitable shape.

As shown in FIG. 2, the solar laminate 102 has a laminate structure that includes several layers 118. Layers 118 may include, for example, glass layers, non-reflective layers, electrical connection layers, n-type silicon layers, p-type silicon layers, and/or backing layers. One or more layers 118 may also include solar cells (not shown). In other embodiments, solar laminate 102 may have more or fewer, including one, layers 118, may have different layers 118, and/or may have different types of layers 118.

As shown in FIG. 1, frame 104 circumscribes solar laminate 102. Frame 104 is coupled to solar laminate 102, as best shown in FIG. 2. Frame 104 assists in protecting edges 110 of solar laminate 102. Example frame 104 includes an outer surface 130 spaced apart from solar laminate 102 and an inner surface 132 adjacent solar laminate 102. Outer surface 130 is spaced apart from and substantially parallel to inner surface 132. In the example embodiment, frame 104 is made of aluminum. More particularly, in some embodiments frame 104 is made of 6000 series anodized aluminum. In other embodiments, frame 104 may be made of any other suitable material providing sufficient rigidity including, for example, rolled or stamped stainless steel, plastic, or carbon fiber.

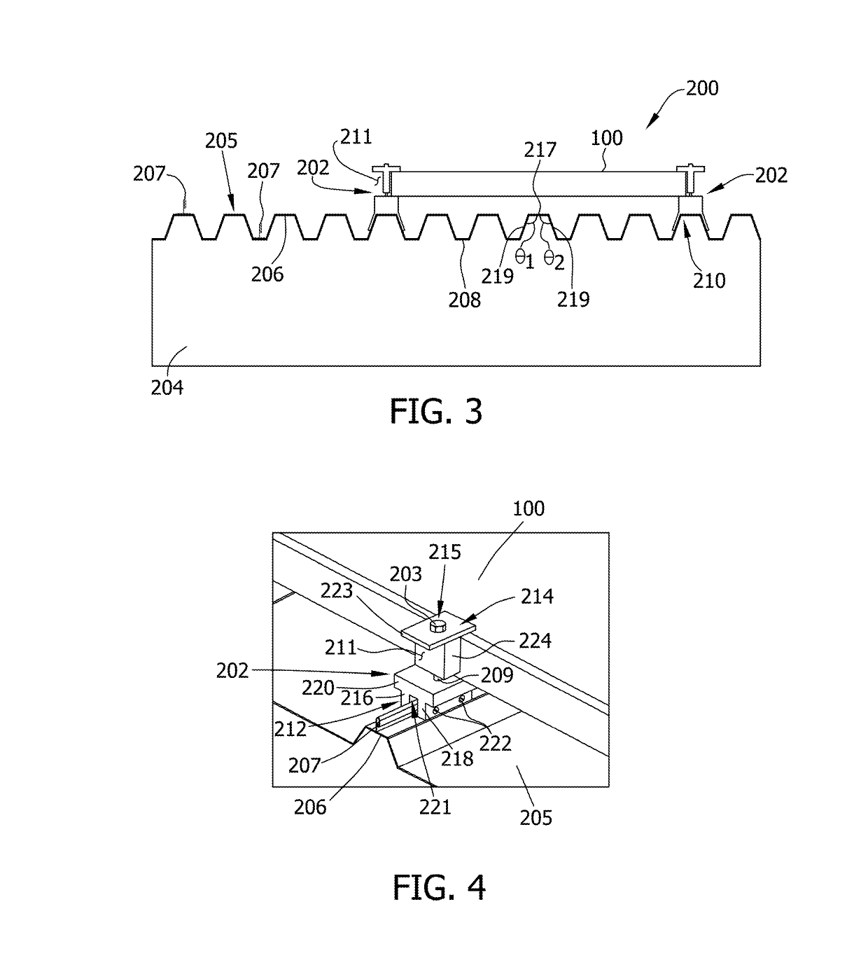

Referring now to FIG. 3, a solar module assembly, indicated generally at 200, is mounted to a structure 204, for example, a building. In the illustrated embodiment, solar module assembly 200 includes a solar module 100 and two clamps 202. Each clamp 202 is attached to a surface 205 of structure 204. Surface 205 of structure 204 is, for example, the roof of a building. Furthermore, each clamp 202 is attached to and clamps solar module 100 in place. Although only a single solar module 100 is shown in FIG. 3, solar module assembly 200 may include a plurality of solar modules 100 attached to surface 205 of structure 204. Moreover, although only two clamps 202 are shown, solar module assembly 200 may include more or fewer clamps 202. Additionally, each clamp 202 may be the same as or different than one or more other clamps 202 in the solar module assembly 200.

In the example embodiment, surface 205 of structure 204 is a corrugated metal roof having a plurality of ridges 206 that define valleys 208 between adjacent ridges 206. Each ridge 206 includes two side walls 219 connected by a top wall 217. Angles θ₁ and θ₂ are defined between top wall 217 and side walls 219. Angles θ₁ and θ₂ may be equivalent or dissimilar. One or more ridges 206 and/or valleys 208 may include a protrusion 207. Protrusion 207 may be, for example, a junction on surface 205 where at least two pieces of metal join together to form a seam. Clamps 202 are configured to straddle a ridge 206 when positioned on surface 205 of the structure 204. Clamps 202 may also be configured to connect to the surface 205 in a valley 208 between adjacent ridges 206. Still further, clamps 202 may be configured to connect to protrusions 207 on surface 205. A structural adhesive compound 210 may be used to bond each clamp 202 with a respective ridge 206 and/or protrusion 207 on surface 205.

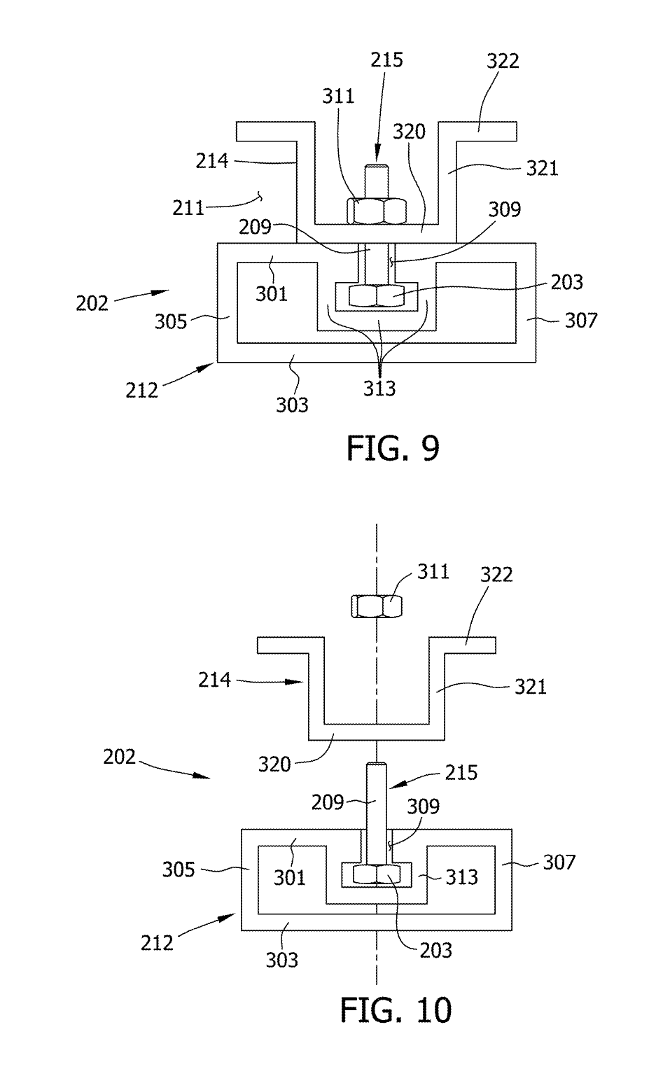

Referring to FIGS. 3-10, 13, and 15, clamps 202 of the present disclosure are configured, for example, as an assembly including a base 212, a bracket 214, and a fastener 215. Base 212 is configured for attachment to surface 205 having a multi-planar profile, such as a corrugated roof. In example embodiments, base 212 is connected to surface 205 without penetrating its surface, for example, with a structural adhesive compound. Fastener 215 is configured to connect base 212 and bracket 214. Base 212 and bracket 214 are configured to collaboratively define a mounting region, generally indicated at 211, for receiving solar module 100. Fastener 215 is configured to selectively apply a clamping force to solar module 100 between base 212 and bracket 214. Fastener 215 is further configured to allow adjustment of the distance between base 212 and bracket 214.

Clamp 202 (including its individual parts, for example, base 212, bracket 214, and fastener 215) may be constructed of any suitable material for the purposes described herein. In the example embodiment, clamp 202 is made of aluminum. In other embodiments, clamp 202 may be made of any suitable material including, for example, other metals, plastics, fiberglass, or any combination thereof.

Base 212 and bracket 214 of the illustrated embodiment are die cast. In other embodiments, base 212 and bracket 214 may be formed by any other suitable process including, for example, stamping, machining, and 3D printing.

In an example embodiment shown in FIG. 4, clamp 202 includes base 212, a t-shaped bracket 214, and fastener 215. Base 212 includes a first segment 216 spaced apart from a second segment 218 by a third segment 220. The first, second, and third segments 216, 218, and 220 may be integrally molded or formed as separate parts. First and second segments 216 and 218 extend downward from opposing ends of third segment 220 such that base 212 is generally U-shaped and configured for attachment to surface 205 of structure 204. More specifically, first segment 216 is substantially parallel to second segment 218, and third segment 220 is substantially orthogonal to the first and second segments 216 and 218. As shown in the example embodiment, first segment 216 and second segment 218 are positioned on opposite sides of protrusion 207 on ridge 206 on surface 205 of structure 204. Accordingly, first segment 216 and second segment 218 define a gap 221 having a width greater than or equal to a width of protrusion 207. In the illustrated embodiment, at least one of first and second segment 216 and 218 is attached to protrusion 207 by an attachment fastener 222 extending through the segment 216 and/or 218. Optionally, attachment fastener 222 may pass through first segment 216, protrusion 207, and second segment 218 to secure base 212 to surface 205. In an alternative embodiment, first segment 216, second segment 218, and third segment 220 are attached to protrusion 207 with structural adhesive compound 210. Still in another embodiment, only first and second segments 216 and 218 are attached to surface 205 with structural adhesive compound 210.

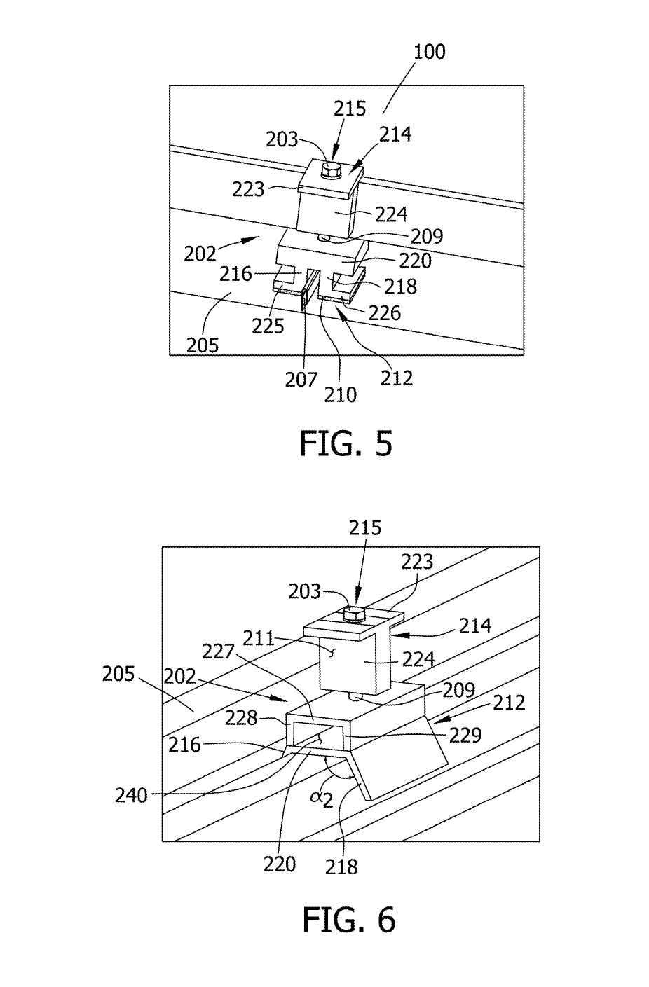

Referring now to the FIG. 5, another example clamp 202 includes base 212, a bracket 214, and fastener 215. Base 212 includes first segment 216 spaced apart from second segment 218 by third segment 220. In the example embodiment, first segment 216 is substantially parallel to second segment 218, and third segment 220 is substantially orthogonal to the first and second segments 216 and 218. In addition, first and second segments 216 and 218 include a fourth segment 225 and a fifth segment 226, respectively. Fourth segment 225 and fifth segment 226 are configured for attachment to surface 205 of structure 204. In the illustrated embodiment, fourth segment 225 and fifth segment 226 are attached to surface 205 of structure 204 with structural adhesive compound 210. In the example embodiment, structural adhesive compound 210 is applied to at least one of fourth and fifth segments 225 and 226 to couple base 212 to surface 205 such that segments 225 and 226 do not contact surface 205. Alternatively, in some embodiments, segments 225 and 226 and surface 205 may contact each other.

In the example embodiment, structural adhesive compound 210 is a substantially liquid adhesive such as, but not limited to, a polyurethane or polyether. When applied, structural adhesive compound 210 reacts with moisture in the air to form a high molecular weight cross link polymer that requires approximately 24 hours to cure to approximately 50% of the maximum tensile strength of the structural adhesive compound 210 to allow for rapid installation. Alternatively, structural adhesive 210 may require any amount of time to cure to any tensile strength. After curing, structural adhesive compound 210 includes a minimum tensile strength of 100 pounds per square inch. Structural adhesive compound 210 includes elastic characteristics that allow a small amount of bracket movement that permits displacements of solar module 100 due to wind. As such, structural adhesive compound 210 reduces the shear stress and fatigue loading resulting from wind. In an example embodiment, structural adhesive compound 210 includes a thickness in a range of between approximately 2 millimeters (mm) to approximately 10 mm. Alternatively, structural adhesive compound 210 may have any thickness that facilitates operation of solar module assembly 200 as described herein. Generally, the thickness of structural adhesive compound 210 is based on the materials to be bonded together.

Furthermore, structural adhesive compound 210 is removable such that solar module 100 and clamp 202 may be removed from surface 205 and re-positioned at a different location either on surface 205 of structure 204 or at a different facility. More specifically, the adhesion bond between clamp 202 and structure 204 may be broken by passing a metal wire between base 212 and ridge top 217. Alternatively, bracket 202 may be removable by any means that facilitates operation of solar module assembly 200 as described herein.

Again referring to the FIG. 5 embodiment, base segments 225 and 226 are spaced apart and extend out from gap 221. Base segment 225 extends from first segment 216 and base segment 226 extends from second segment 218. Base segments 225 and 226 are also spaced apart from and substantially parallel to third segment 220. As shown in the example embodiment, first segment 216 and second segment 218 are positioned on opposite sides of protrusion 207 on structure 204. Accordingly, first segment 216 and second segment 218 define a gap 221 having a width greater than or equal to a width of protrusion 207.

T-shaped bracket 214 of the embodiments shown in FIGS. 4 and 5 include a first portion 223 and a second portion 224. First portion 223 is substantially orthogonal to second portion 224. First portion 223 and second portion 224 may be integrally molded or formed as separate pieces.

Fastener 215, shown in FIGS. 4-10, 13, and 15, is configured to connect bracket 214 and base 212 while allowing adjustment of the distance between bracket 214 and base 212. Fastener 215 includes a head 203 and a shaft 209. Fastener 215 is further configured to generate a force to selectively clamp solar module 100 between bracket 214 and base 212 when rotatably engaged to base 212. Fastener 215 also allows for adjustment of the distance in mounting region 211 between first portion 223 of bracket 214 and third segment 220 of base 212. Shaft 209 of fastener 215 of the illustrated embodiment of clamp 202 in FIGS. 4 and 5 extends through an aperture (not shown in FIG. 4 or 5) in bracket 214 and connects bracket 214 to third segment 220 of base 212.

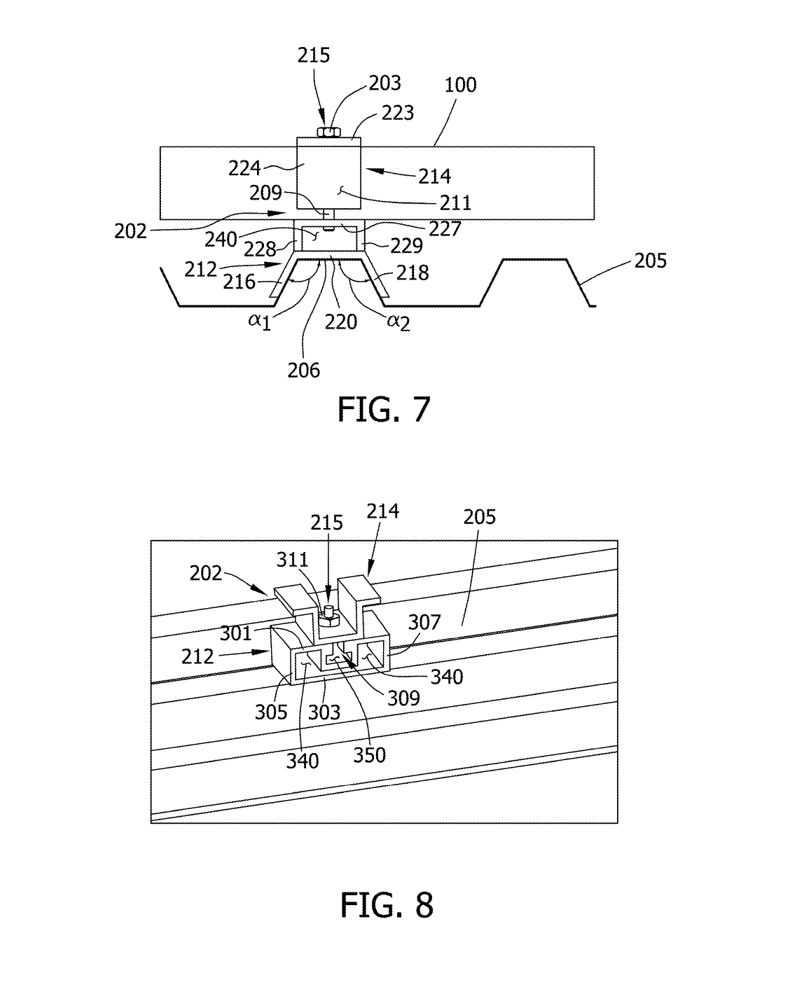

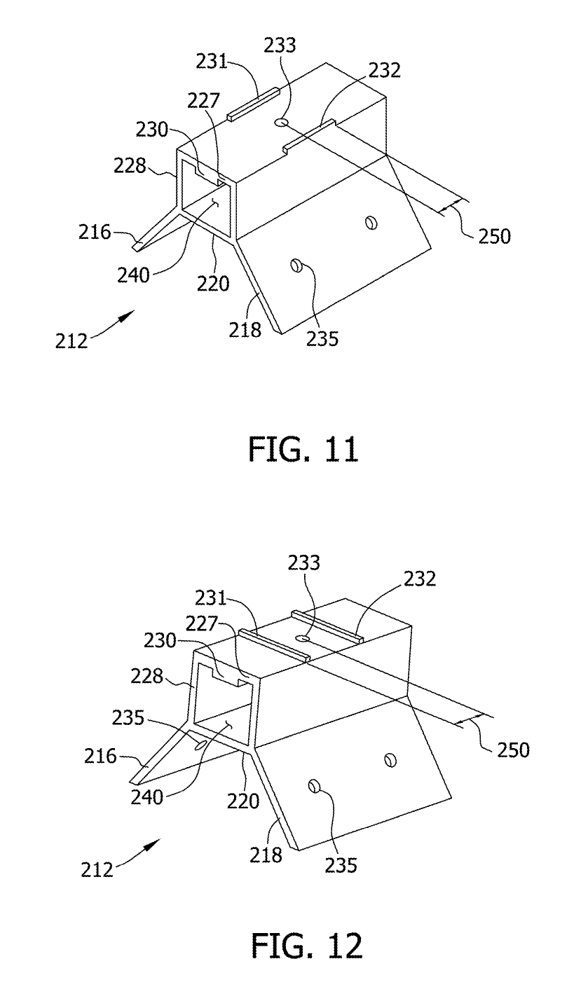

Referring now to the embodiment shown in FIGS. 6 and 7, clamp 202 includes base 212, bracket 214, and fastener 215. Base 212 includes first segment 216 spaced apart from second segment 218. First and second segments 216 and 218 are connected by third segment 220. In the illustrated embodiment, a first angle α₁ is defined between first segment 216 and third segment 220, and a second angle α₂ is defined between second segment 218 and third segment 220. First angle α₁ and second angle α₂ may be equivalent or dissimilar. In an example embodiment, first and second angles α₁ and α₂ are each greater than or equal to 90 degrees and less than 180 degrees. In some embodiments, first angle α₁ and second angle α₂ each substantially match one of the angles θ₁ and θ₂ (shown in FIG. 3) created by top wall 217 and side walls 219 of ridge 206. In the illustrated embodiment, first segment 216, second segment 218, and third segment 220 are attached to surface 205 of structure 204 with structural adhesive compound 210 as described herein. Alternatively, first segment 216, second segment 218, and third segment 220 are attached to surface 205 by other fastening devices (e.g., screws, nails, etc.). In some embodiments, first segment 216 and second segment 218 may include one or more apertures to receive the other fastening devices. In the embodiments illustrated in FIGS. 11 and 12, for example, first segment 216 and second segment 218 include apertures 235. In some embodiments, the apertures are covered by a patch or sheet of water proofing material (broadly, a fluid barrier) to prevent water leakage onto or into the structure on which solar module 100 is mounted. Suitable fluid barriers include, for example and without limitation, ethylene propylene diene monomer (EPDM) rubber. The fluid barrier may be attached to an inner surface of base 212 using suitable fastening means, such as adhesives.

Referring again to FIGS. 6 and 7, base 212 also includes a fourth segment 227 spaced apart from, substantially parallel and attached to third segment 220 by a fifth segment 228 and a sixth segment 229. In the illustrated embodiment, a volume 240 is defined by third segment 220, fourth segment 227, fifth segment 228, and sixth segment 229. In some embodiments, electrical wires or cables from solar module 100 are routed through volume 240, thereby providing a cable management solution.

As shown in FIGS. 11 and 12, in other embodiments of base 212, fourth segment 227 includes a web 230, an opening 233 configured to receive fastener 215, and solar module alignment members 231 and 232. Web 230 of fourth segment 227 is configured to strengthen fourth segment 227. Specifically, web 230 is attached to base 212 and helps fourth segment 227 support the weight of solar modules 100 and resist stresses and strains acting upon solar module 100. In the illustrated embodiment, web 230 is integrally molded with fourth segment 227 within volume 240. In other embodiments, web 230 may be integrally molded or attached to fourth segment 227, fifth segment 228, or sixth segment 229 within or outside volume 240.

In the embodiment of base 212 shown in FIGS. 11 and 12, alignment members 231 and 232 extend from fourth segment 227. Alignment member 231 is substantially parallel to alignment member 232. Alignment members 231 and 232 are configured to direct alignment of solar module 100 with respect to base 212, under t-shaped bracket 214. When one or more solar modules 100 are positioned upon base 212, alignment members 231 and 232 direct the solar modules 100 into parallel alignment under t-shaped bracket 214 at a distance 250 from fastener 215. Moreover, in some embodiments, alignment members 231 and 232 help align bracket 214 relative to base 212 and prevent rotation of bracket 214 relative to base 212. Alignment members 231 and 232 may be integrally formed with fourth segment 227 or may be separate portions attached (such as by welding, gluing, etc.) to fourth segment 227. Alignment members 231 and 232 may be made of the same material or a different material than the rest of base 212.

Referring back to FIGS. 6 and 7, t-shaped bracket 214 includes a first portion 223 and a second portion 224. First portion 223 is substantially orthogonal to second portion 224. Again, first portion 223 and second portion 224 may be integrally molded or formed as separate portions.

Fastener 215, shown in FIGS. 6 and 7, is configured to connect bracket 214 and base 212 while allowing adjustment of the distance between bracket 214 and base 212. The shaft 209 of fastener 215 extends through an aperture in bracket 214 and connects bracket 214 to fourth segment 227 of base 212. Fastener 215 is further configured to generate a force to selectively clamp solar module 100 between bracket 214 and base 212 when fastener 215 is rotatably engaged to base 212. Fastener 215 also allows for adjustment of the distance in mounting region 211 between first portion 223 of bracket 214 and fourth segment 227 of base 212.

Referring now to the embodiment shown in FIGS. 8, 9, and 10, clamp 202 includes base 212, bracket 214, and fastener 215. Base 212 includes a top 301 and a bottom 303 connected by two sides 305 and 307. Top 301, bottom 303, and sides 305 and 307 define a volume 340 within base 212. In the illustrated embodiment, base bottom 303 is attached to surface 205 of structure 204 with structural adhesive compound 210 as described above. Top 301 includes an opening shown generally at 309. In an example embodiment, the width of opening 308 corresponds to the diameter of shaft 209 of fastener 215. In the illustrated embodiment, base 212 includes an internal divider 313 defining a second volume 350 which is disposed within volume 340. Volume 350 is accessible from top 301 of base 212 via opening 309. In the illustrated embodiment, the cross sectional area of volume 350 corresponds to the cross sectional area of a portion (e.g., head 203) of fastener 215. In the illustrated embodiment, the cross sectional area of volume 350 substantially matches the cross sectional area of head 203 of fastener 215 such that fastener 215 is rotatably fixed with respect to base 212. When head 203 of fastener 215 is disposed in second volume 315, internal divider 313 prevents rotation of fastener 215 by engaging and preventing rotation of head 215.

Bracket 214 of the embodiment shown in FIGS. 8, 9, and 10 includes an upper portion 322 and a lower portion 320 connected by a middle portion 321. In the illustrated embodiment, middle portion 321 is substantially orthogonal to upper portion 322 and lower portion 320. Lower portion 320 is substantially parallel and connected to upper portion 322. Lower portion 320, middle portion 321, and upper portion 322 may be integrally molded or formed as separate portions.

Fastener 215 shown in FIGS. 8, 9, and 10, is configured to connect bracket 214 and base 212 while allowing adjustment of the distance between bracket 214 and base 212. Shaft 209 of fastener 215 of the illustrated embodiment of clamp 202 extends through opening 309 in base 212 and through an aperture in bracket 214 and engages a nut 311. Fastener 215 is further configured to generate a force to selectively clamp solar module 100 between bracket 214 and base 212 when rotatably engaged to nut 311. Fastener 215 in combination with nut 311 allows for adjustment of the distance in mounting region 211 between upper portion 322 of bracket 214 and top 301 of base 212.

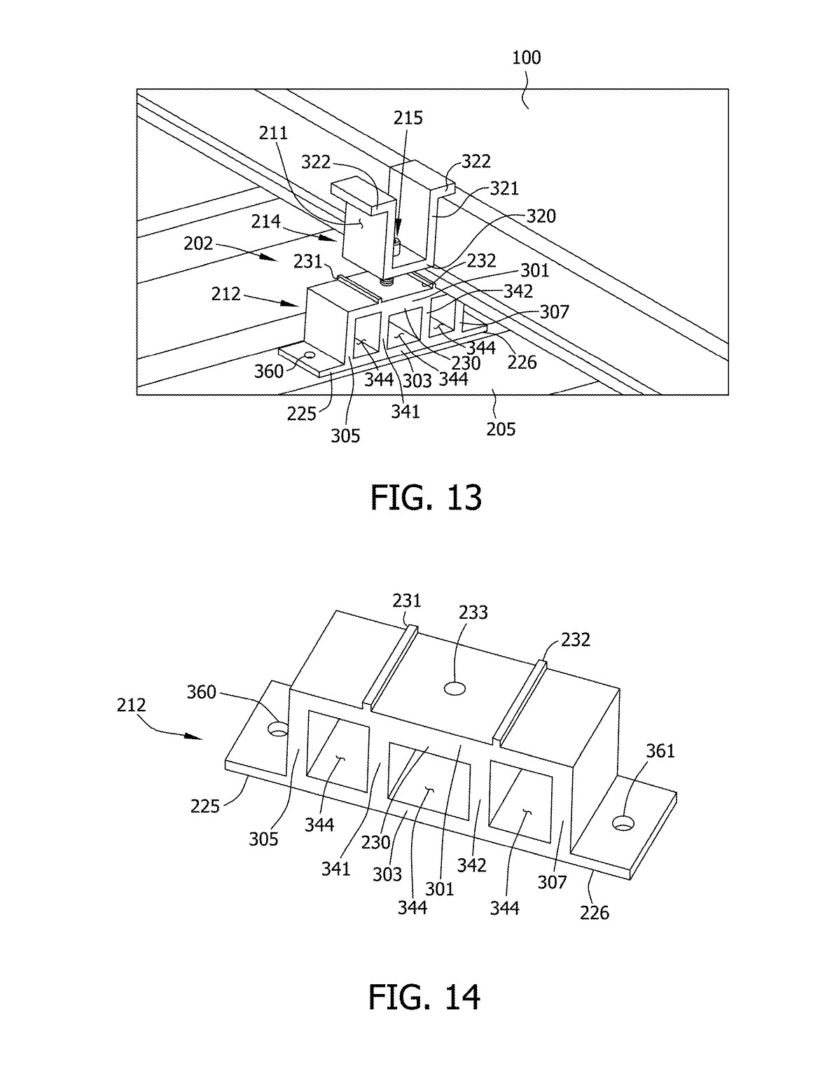

Another embodiment of clamp 202 shown in FIGS. 13 and 14 includes base 212, bracket 214, and fastener 215. As shown in FIG. 14, base 212 includes top 301 and bottom 303 connected by two sides 305 and 307. Strengthening members 341 and 342 extend between the top 301 and bottom 303 at a location between sides 305 and 307. Strengthening members 341 and 342 are configured to support top 301 of base 212 and the weight of solar modules 100 and resist stresses and strains acting upon solar module 100. Base 212 also includes base members 225 and 226 extending from the junction of bottom 303 and sides 305 and 307, respectively. Top 301, bottom 303, sides 305 and 307, and strengthening members 341 and 342 define volumes 344 within base 212. In some embodiments, electrical wires or cables from solar module 100 are routed through volume one or more volumes 344, thereby providing a cable management solution.

Base 212 further includes alignment members 231 and 232, opening 233, and web 230. Alignment member 231 is substantially parallel to alignment member 232. Alignment members 231 and 232 are configured to direct alignment of solar module 100 onto base 212, under t-shaped bracket 214. In some embodiments, alignment members 231 and 232 help align bracket 214 relative to base 212 and prevent rotation of bracket 214 relative to base 212. Alignment members 231 and 232 may be integrally formed with top 301 or may be separate portions attached (such as by welding, gluing, etc.) to top 301. Alignment members 231 and 232 may be made of the same material or a different material than the rest of base 212. Web 230 is attached to and helps top 301 support the weight of solar modules 100 and resist stresses and strains acting upon solar module 100. In example embodiments, web 230 is integrally molded to top 301 within one or more of volumes 344.

In the embodiment shown in FIGS. 13 and 14, base bottom 303 is attached to surface 205 of structure 204 (not shown in FIG. 14) with structural adhesive compound 210 as described above. In alternative embodiments, base 212 may be attached to surface 205 of structure 204 by other fastening devices (e.g., screws, nails, etc.) through apertures 360 and 361 in base members 225 and 226, respectively. In some embodiments, apertures 360 and 361 are covered by a patch or sheet of water proofing material (broadly, a fluid barrier) to prevent water leakage onto or into the structure on which solar module 100 is mounted. Suitable fluid barriers include, for example and without limitation, ethylene propylene diene monomer (EPDM) rubber. The fluid barrier may be attached to a bottom or lower surface of base 212 using suitable fastening means, such as adhesives.

Referring again to FIG. 13, bracket 214 includes an upper portion 322 and a lower portion 320 connected by a middle portion 321. In the illustrated embodiment, middle portion 321 is substantially orthogonal to upper portion 322 and lower portion 320. Lower portion 320 is substantially parallel and connected by middle portion 321 to upper portion 322. Lower portion 320, middle portion 321, and upper portion 322 may be integrally molded or formed as separate portions.

Fastener 215 shown in FIG. 13 is configured to connect bracket 214 and base 212 while allowing adjustment of the distance between bracket 214 and base 212. Shaft 209 of fastener 215 extends through an aperture (not shown) in bracket 214 and is received by opening 233 to connect bracket 214 to base top 301. Fastener 215 is further configured to generate a force to selectively clamp solar module 100 between bracket 214 and base 212 when fastener 215 is rotatably engaged to base 212. Fastener 215 also allows for adjustment of the distance in mounting region 211 between upper portion 322 of bracket 214 and base top 301.

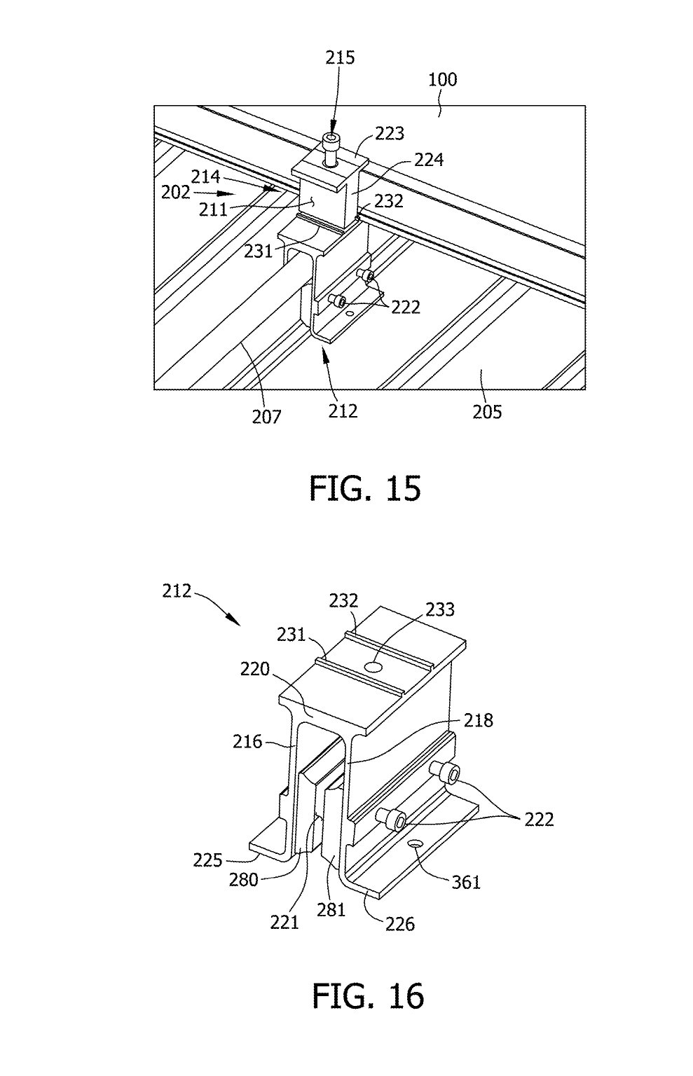

Referring now to FIGS. 15-18, another embodiment of clamp 202 includes base 212, t-shaped bracket 214, and fastener 215. As shown in FIGS. 15-18, base 212 includes a first segment 216 spaced apart from a second segment 218 by a third segment 220. The first, second, and third segments 216, 218, and 220 may be integrally molded or formed as separate parts. First and second segments 216 and 218 extend downward from opposing ends of third segment 220 such that base 212 is generally U-shaped and configured for attachment to surface 205 of structure 204. More specifically, first segment 216 is substantially parallel to second segment 218, and third segment 220 is substantially orthogonal to the first and second segments 216 and 218. As shown in FIG. 15, when installed on structure 204, first segment 216 and second segment 218 are positioned on opposite sides of protrusion 207 on surface 205 of structure 204. Accordingly, first and second segments 216 and 218 define a gap 221 having a width greater than or equal to a width of protrusion 207.

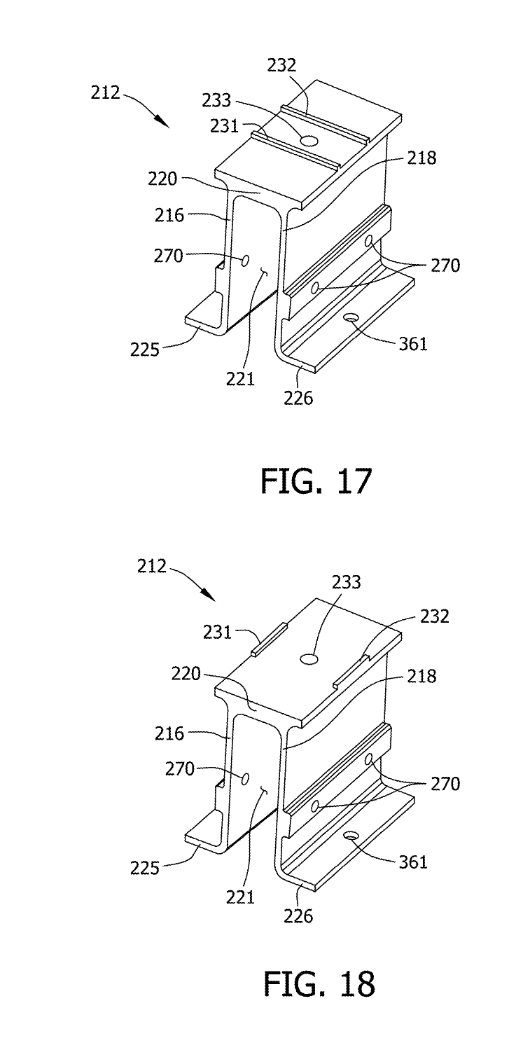

As shown in the embodiments in FIGS. 15-18, base 212 also includes clamping members 280 and 281 and base segments 225 and 226. Clamping members 280 and 281 are omitted in FIGS. 17 and 18 to show underlying features of base 212. Clamping members 280 and 281 are positioned within gap 221 and are received by attachment fasteners 222 extending through openings 270 (shown in FIGS. 17 and 18) in first and second segment 216 and 218. Clamping members 280 and 281 are configured to adjust the width of gap 221 to clamp to protrusion 207 and secure base 212 to structure 204.

Base segments 225 and 226 are spaced apart and extend out from gap 221. Base segment 225 extends from first segment 216 and base segment 226 extends from second segment 218. Base segments 225 and 226 are also spaced apart from and substantially parallel to third segment 220. As shown in the example embodiment, first segment 216 and second segment 218 are positioned on opposite sides of protrusion 207 on structure 204.

In the embodiments of base 212 shown in FIGS. 15-18, base segments 225 and 226 are attached to surface 205 of structure 204 with structural adhesive compound 210. In alternative embodiments, base segments 225 and 226 may be attached to surface 205 of structure 204 by other fastening devices (e.g., screws, nails, etc.) through apertures 361 in base members 225 and 226, only one of which is shown in FIGS. 15-18.

As shown in FIGS. 15-18, base 212 includes alignment members 231 and 232 and opening 233. Alignment member 231 is positioned substantially parallel to alignment member 232. Alignment members 231 and 232 are configured to direct alignment of solar module 100 onto base 212, under t-shaped bracket 214. Moreover, in some embodiments, alignment members 231 and 232 help align bracket 214 relative to base 212 and prevent rotation of bracket 214 relative to base 212. Alignment members 231 and 232 may be integrally formed with third segment 220 or may be separate portions attached (such as by welding, gluing, etc.) to third segment 220. Alignment members 231 and 232 may be made of the same material or a different material than the rest of base 212.

T-shaped bracket 214 of the embodiment shown in FIG. 15 includes a first portion 223 and a second portion 224. First portion 223 is substantially orthogonal to second portion 224. First portion 223 and second portion 224 may be integrally molded or formed as separate pieces.

Fastener 215 shown in FIG. 15 is configured to connect bracket 214 and base 212 while allowing adjustment of the distance between bracket 214 and base 212. Shaft 209 of fastener 215 extends through an aperture in bracket 214 and is received by opening 233 to connect bracket 214 to third segment 220 of base 212. Fastener 215 is further configured to generate a force to selectively clamp solar module 100 between bracket 214 and base 212 when fastener 215 is rotatably engaged to base 212. Fastener 215 also allows for adjustment of the distance in mounting region 211 between first portion 223 of bracket 214 and third segment 220 of base 212.

Embodiments of the methods and systems described herein achieve superior results compared to prior methods and systems. For example, the mounting assemblies described herein simplify the installation of solar modules onto a structure. More specifically, the embodiments described herein use an adhesive to bond a mounting clamp to a structure. As such, the mounting clamp described herein eliminates the need to penetrate a roof with fasteners, and, therefore, do not damage roofs during installation or affect the structural integrity of the roof. The embodiments and methods described above use lightweight mounting structures that either reduce the ballast weight on the roof or eliminate the need for a ballast altogether. As such, time and cost expended calculating proper placement and load limits are saved.

Embodiments of the assemblies may also reduce assembly labor and time, and therefore the cost of installing the system. The assemblies may also be cheaper due to the elimination of numerous fasteners needed at an installation site. Furthermore, the above-described mounting assemblies enable simple removal of solar modules for installation at a different location. Moreover, the adhesives used in the above-described embodiments have a predetermined modulus of elasticity that enables the adhesive to stretch to account for small displacements of the solar module due to wind. Generally, solar modules installed using embodiments of the mounting brackets may be easier, faster, less expensive and/or safer to install than solar modules using prior systems.

When introducing elements of the present invention or the embodiments thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the invention, it is intended that all matter contained in the above description and shown in the accompanying figures shall be interpreted as illustrated and not in a limiting sense.

1. A solar module clamp for securing a solar module to a structure, the solar module clamp comprising:
a base configured for attachment to the structure, the base including a first segment spaced apart from a second segment, the first and second segments connected by a third segment;
a t-shaped bracket including a first portion and a second portion, the first portion connected substantially orthogonal to the second portion;
a fastener extending through the t-shaped bracket and connected to the base, the fastener configured to selectively clamp the solar module between the base and the t-shaped bracket.

2. The solar module clamp of claim 1, wherein the first segment is substantially parallel to the second segment and the third segment is substantially orthogonal to the first segment and the second segment.

3. The solar module clamp of claim 1, wherein the first segment and the second segment of the base are configured to be positioned on opposite sides of a protrusion on the structure, and wherein the first segment and second segment define a gap having a width greater than or equal to a thickness of the protrusion.

4. (canceled)

5. The solar module clamp of claim 3, further comprising at least one clamping member within the gap between the protrusion and the first segment or second segment.

6. The solar module clamp of claim 3, further comprising an attachment fastener extending through at least one of the first segment and the second segment and configured to engage the protrusion.

7. (canceled)

8. The solar module clamp of claim 1, wherein the third segment of the base and the first portion of the t-shaped bracket are configured to clamp the solar module there between using a clamping force generated by the fastener.

9. The solar module clamp of claim 1, wherein the base and the t-shaped bracket are configured to clamp a second solar module therebetween using a clamping force generated by the fastener.

10. (canceled)

11. The solar module clamp of claim 1, wherein the first segment includes a fourth segment, the second segment includes a fifth segment, the fourth segment and the fifth segment extending outward from a gap defined between the first segment and second segment, the fourth segment and the fifth segment spaced apart and substantially parallel to the third segment, wherein the fourth segment and the fifth segment are configured for attachment to a surface of the structure.

12. (canceled)

13. (canceled)

14. The solar module clamp of claim 1, wherein a first angle is defined between the first segment and the third segment, a second angle is defined between the second segment and the third segment, wherein each angle is greater than or equal to 90 degrees and less than 180 degrees, and wherein the first and second angles each substantially match a respective angle on a surface feature of the structure.

15. (canceled)

16. The solar module clamp of claim 14, wherein a first angle is defined between the first segment and the third segment, a second angle is defined between the second segment and the third segment, wherein each angle is greater than or equal to 90 degrees and less than 180 degrees, and wherein the first and second angles are equal.

17. The solar module clamp of claim 1, wherein the base further comprises a fourth segment spaced apart from, substantially parallel to, and attached to the third segment by a fifth segment and a sixth segment, wherein the fastener is connected to the fourth segment and the fourth segment is configured to support the solar module.

18. The solar module clamp of claim 17, wherein the fourth segment of the base and the first portion of the t-shaped bracket are configured to clamp the solar module therebetween using a clamping force generated by the fastener.

19. The solar module clamp of claim 17, wherein the fourth segment includes at least one of a web for strengthening the fourth segment and substantially parallel alignment members for aligning the solar module thereon.

20-29. (canceled)

30. A solar module assembly comprising:
a solar panel;
a frame coupled to the solar panel;
a clamp comprising:
a base configured for attachment to a structure, the base including a first segment spaced apart from a second segment, the first and second segments connected by a third segment;
a bracket; and
a fastener extending through the bracket and connected to the base, the fastener configured to selectively clamp the frame between the base and the bracket.

31. The assembly of claim 30, wherein the base of the clamp is attached around a protrusion of the structure between the first segment and the second segment.

32. The assembly of claim 30, wherein the base of the clamp is attached to a protrusion of the structure by the first segment, the second segment, and the third segment.

33. The assembly of claim 30, wherein the base of the clamp is attached to the structure without penetrating a surface feature of the structure.

34. The assembly of claim 33, wherein the base of the clamp is attached to a surface feature of the structure with a structural adhesive compound.

35. The assembly of claim 30, wherein the fastener is configured to engage the third segment of the base.

36. (canceled)

37. A clamping assembly for securing a solar module to a structure, the clamping assembly comprising:
a base configured for attachment to a multi-planar roof of the structure;
a bracket, wherein the base and the bracket collaboratively define a mounting region for receiving a portion of the solar module;
a fastener connecting the base and the clamp configured to selectively apply a clamping force to the portion of the solar module.

38. (canceled)
